(19) United States
(12) Patent Application Publication
(10) Pub. No.: US 2006/0146515 A1
(43) Pub. Date: Jul. 6, 2006

(54) Light emitting decoration apparatus

(76) Inventors: Kwanghyun Hwang, KYEONGGIDO (KR); Seokhwang Kim, Incheon (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 10/544,984

(22) PCT Filed: Feb. 10, 2004
(86) PCT No.: PCT/KR04/00255

§ 371 Date: Aug. 9, 2005

(30) Foreign Application Priority Data
Feb. 10, 2003 (KR) 10-2003-008306
May 30, 2003 (KR) 10-2003-0034979
Sep. 30, 2003 (KR) 10-2003-0067965

(51) Int. Cl. F21V 9/16

(52) U.S. Cl. 362/84; 362/122

(57) ABSTRACT

The light emitting decoration apparatus includes a sheet type light emitting member (40) that has a transparent electric conductive layer (641), fluorescent layer (66), and first and second electrode layer (64) that electrically isolated each other. Each electrode layer of the light emitting member has electric junction portions. The electric junction portions are adapted to be connected to wire type conductors by way of passing through.

### BACKGROUND OF THE INVENTION

1. Field of the Invention

The present invention relates to a decorative illuminating apparatus, and more particularly, to a decorative illuminating apparatus using an EL sheet.

2. Description of the Related Art

Electro-luminescent (EL) sheet is formed by depositing a fluorescent material on an organic film or a linear structural object. As an AC voltage is applied to the EL sheet, an electric field causes the fluorescent material to rapidly charge and discharge, resulting in the emission of light during each cycle. This phenomenon is called the electro-luminescence. A thin, lightweight sheet having a property of the electro-luminescence is called the EL sheet. Since it can be formed in various shapes, the EL sheet is widely used as a back light of an electronic apparatus, a signal plate, and the like.

### SUMMARY OF THE INVENTION

An object of the present invention is to provide a decorative apparatus illuminating light and having various shapes formed by using an EL sheet.

Another object of the present invention is to provide an illuminating member having various shapes formed by using an EL sheet.

Still another object of the present invention is to provide a method of fabricating an illuminating member having various shapes formed by using an EL sheet.

Further still another object of the present invention is to provide an arrangement where a plurality of cables can be connected to an EL sheet, thereby obtaining various decorative shapes.

Further still another object of the present invention is to provide an assembly where an illuminating member using an EL sheet and a cable can be simply and firmly connected.

Further still another object of the present invention is to provide a cable capable of being connected to a decorative illuminating apparatus in various manners.

According to an aspect of the present invention, there is provided a decorative illuminating apparatus comprising: an illuminating member having a shape of a sheet, the illuminating member comprising a transparent conductive layer, a fluorescent layer, and first and second electrode layers electrically isolated from each other, wherein electrical connection portions are provided to the first and second electrode layers of the illuminating member, and wherein a conductive wire passes through each of the electrical connection portions.

It is preferable that the second electrode layer is in a contact with the transparent conductive layer.

It is preferable that the fluorescent layer is interposed between the transparent layer and the first electrode layer, wherein the transparent layer is exposed at a region where the fluorescent layer and the first electrode layer are not formed, wherein the second electrode layer covers the exposed region of the transparent layer and is electrically isolated from the electrode layers.

It is preferable that the fluorescent layer extends between the first electrode layer and the transparent layer and between the second electrode layer and the transparent layer.

It is preferable that the decorative illuminating apparatus further comprises a cable for supplying an electrical power to the electrical connection portions, wherein the cable has two conductors.

It is preferable that the decorative illuminating apparatus further comprises a connector having two connection pins connected to the electrical connection portions, wherein the two conductors of the cable are separately connected to the connector.

It is preferable that the decorative illuminating apparatus further comprises first and second connection rings passing through the illuminating member and connected to the electrical connection portions, wherein the two connection pins of the connector are inserted into the first and second connection rings, respectively.

It is preferable that the illuminating member further comprises a moisture proof layer at the opposite side of a light-emitting side of the illuminating member.

It is preferable that the illuminating member further comprises a printing layer at a light-emitting side of the illuminating member, and a figure is printed on the printing layer.

It is preferable that the illuminating member further comprises a layer covering outer end portions of the first or second electrode layer so that the first or second electrode layer is not externally exposed.

It is preferable that the illuminating member comprises a central portion and a plurality of extending portions extending from the central portion in a radial direction, thereby forming a flower-like shape, and the electrical connection portion is provided at the central portion.

It is preferable that the decorative illuminating apparatus further comprises a coupling means having a support element and a fixing element, wherein the illuminating member is interposed between the support element and the fixing element, wherein the support element and the fixing element are detachably assembled, wherein the coupling means covers the electrical connection portion.

It is preferable that the decorative illuminating apparatus further comprises a base where the cable is detachably fixed.

It is preferable that the base comprises a circuit board having a connector, wherein the two conductors of the cable are connected to the connector of the circuit board.

It is preferable that the decorative illuminating apparatus further comprises a circuit unit for supplying an electrical power through the cables, wherein the circuit unit comprises a plurality of inverter devices corresponding to the cables.

It is preferable that the decorative illuminating apparatus further comprises a circuit unit for supplying an electrical power through the cables, wherein the cables are divided into groups having one or more cables, and separate power supply devices are provided to the groups.

According to another aspect of the present invention, there is provided a decorative illuminating apparatus comprising: an illuminating member made of an EL sheet; and a cable used for supplying an electrical power to the EL sheet, wherein the cable comprises two conductors and an insulating coat for covering the two conductors, wherein a connection passages is provided to the insulating coat to connect with each of the two conductors.

It is preferable that the decorative illuminating apparatus further comprises a branch cable which is connected to the cable through the connection passage.

According to still another aspect of the present invention, there is provided a method of fabricating an illuminating member, the method comprising steps of: preparing a transparent electrode layer; forming a fluorescent layer on the transparent electrode layer except for a first region of the transparent layer, thereby exposing the first region and forming an exposed transparent layer; forming a dielectric layer on the fluorescent layer except for the first region, thereby still exposing the exposed transparent layer; forming a first electrode layer on the dielectric layer except for the first region, thereby still exposing the exposed transparent layer; and forming a second electrode layer at the same time, after, or before the step of forming the first electrode layer, wherein the second electrode layer covers the exposed transparent layer and is apart from the first electrode layer.

It is preferable that the method further comprise a step of forming a moisture proof layer on the first electrode layer.

It is preferable that the moisture proof layer is formed except for a second region of a lower electrode layer, thereby exposing the electrode layer.

It is preferable that in the step of forming the electrode layer, the electrode layer is formed so that a third region of the dielectric layer is exposed, wherein the method further comprises a step of forming a through hole having a smaller size than the third region.

It is preferable that wherein the method further comprise a step of forming a printing layer by printing a desired figure on the transparent electrode layer.

It is preferable that the method further comprise a step of forming a glossy layer on the printing layer.

It is preferable that outer end portions of the first electrode layer are covered with other layers.

According to further still another aspect of the present invention, there is provided a decorative apparatus comprising: an illuminating member made of an EL sheet, the illuminating member comprising a central portion and a plurality of extending portion, thereby the illuminating member having a shape of a flower; a cable connected to the EL sheet, the cable having a shape of a stem; and a power supply device for supplying an electrical power to the EL sheet through the cable. It is preferable that the decorative apparatus further comprises another EL sheet having a shape of a petal, wherein the power supply device supplies the electrical power to another EL sheet.

According to further still another aspect of the present invention, there is provided a decorative illuminating apparatus comprising: a plurality of layers including an electrode layer, wherein the electrode layer comprises an illuminating member having an EL sheet, wherein the EL sheet is divided into two regions by a dividing line, and wherein two connection rings are provided to pass though the two divided EL sheets, respectively.

It is preferable that outer end portion of the EL sheet is covered with an insulating coat layer, so that the EL sheet is not externally exposed.

It is preferable that the illuminating member comprises a central portion and a plurality of extending portions extending from the central portion in a radial direction, thereby forming a flower-like shape

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a decorative illuminating apparatus according to an embodiment of the present invention;

FIG. 2 illustrates cross sectional views (a) and (b) taken along lines A-A′ and B-B′, respectively, of the decorative illuminating apparatus of FIG. 1;

FIG. 3 is a perspective view of a circuit board in the decorative illuminating apparatus of FIG. 2;

FIG. 4 is an exploded view of a decorative illuminating object in the decorative illuminating apparatus;

FIG. 5 illustrates cross sectional views (a) and (b) taken along lines C-C′ and D-D′, respectively, of the decorative illuminating object of FIG. 4 with an illuminating member, a cable, and coupling means being assembled;

FIG. 6 is an enlarged cross sectional view of an assembled portion of an illuminating member and a cable;

FIG. 7 is a cross sectional view taken along a line H-H′ of the decorative illuminating object of FIG. 4 in order to illustrate coupling through holes.

FIG. 8 is a perspective view of a connection ring before lined in an inserting hole;

FIGS. 9 to 12 illustrate a method of fabricating an illuminating member of FIG. 4;

FIG. 13 is a plan view of a circuit board according to an embodiment of the present invention;

FIG. 14 is a plan view of a circuit board according to another embodiment of the present invention;

FIG. 15 is a cross sectional view of an illuminating member according to an embodiment of the present invention;

FIG. 16 illustrates a method of fabricating an illuminating member according to another embodiment of the present invention; (a) is a plan view of the illuminating member and (b) is an enlarged cross sectional view of an end portion of the illuminating member;

FIG. 17 is a plan view of a decorative illuminating object according to another embodiment of the present invention;

FIG. 18 is a cross sectional view taken along the line C-C′ of the decorative illuminating object of FIG. 17;

FIG. 19 is a perspective, partially cutaway view of a cable and other connection parts according to another embodiment of the present invention; and

FIG. 20 is a cross sectional view of additional cables connected to a cable connection portion of FIG. 17.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

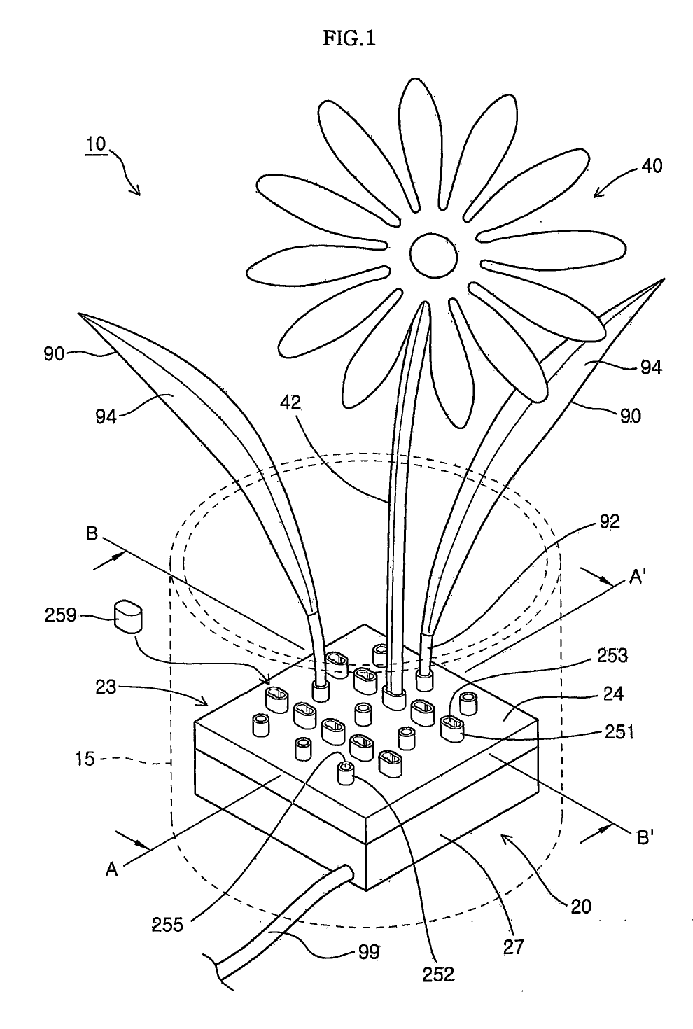

FIG. 1 is a perspective view of a decorative illuminating apparatus according to the present invention. The decorative illuminating apparatus 10 comprises a base 20, a decorative illuminating object 40, and a decorative non-illuminating object 90. The decorative illuminating and non-illuminating objects 40 and 90 are provided on the base 20.

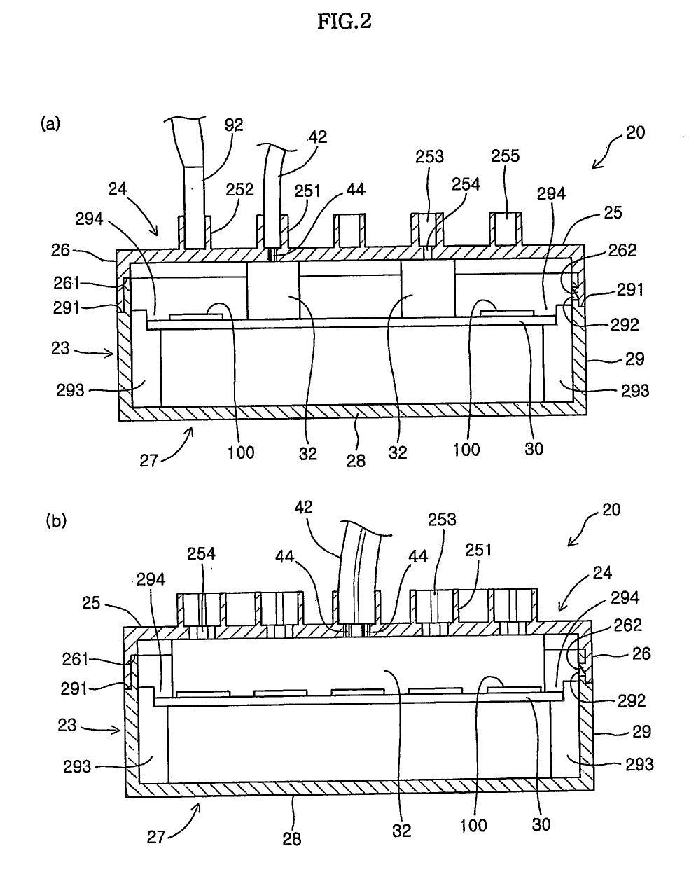

FIG. 2 illustrates cross sectional views (a) and (b) taken along lines A-A′ and B-B′, respectively, of the decorative illuminating apparatus of FIG. 1. The base 20 comprises a case 23 and a circuit board 30 received in the case 23. The case 23 has a shape of rectangular parallelepiped. The case 23 has upper and lower members 24 and 27. The upper member 24 has a top plate 25 and four side walls 26. The top plate 25 has a shape of rectangular. The four side walls 26 extend downward from four edges of the top plate 25. On the top plate are provided a plurality of first and second connection parts 251 and 252 to which a cable 42 of the decorative illuminating object 40 and a lower end portion 92 of the decorative non-illuminating object 90 are inserted. The first connection parts 251 are provided to protrude upward from the top plate 25. Each of the first connection parts 251 has a first connection hole 253 to which the cable 42 of the decorative illuminating object 40 is inserted and fixed. The first connection hole 253 has substantially the same cross section as that of the cable 42 in order to fasten the cable 42. The diameter of the first connection hole 253 is determined to a degree that the cable 42 can be detachably and firmly fixed to the first connection hole 253. A through hole 254 is provided below the first connection hole 253. Two conductors 44 of the cable 42 pass through the through hole 254 into the case 23. The two conductors 44 are connected to a connector 32 described later. Caps 259 are prepared to cover the first connection parts 251 which are not used. The caps 259 prevent water or contaminants from flowing into the case 23 through the first connection holes 253.

The second connection parts 253 are also provided to protrude upward from the top plate 25. Each of the second connection parts 253 has a second connection hole 255 to which the lower end portion 92 of the decorative non-illuminating object 90 is inserted and fixed. The diameter of the second connection hole 255 is determined to a degree that the lower end portion 92 can be detachably and firmly fixed to the second connection hole 255. It will be appreciated by those of ordinary skill in the art that the sizes of the first and second connection holes 253 and 255 may be determined depending on the cable 42 of the decorative illuminating object 40 and the lower end portion of the decorative non-illuminating object 90.

A step portion 261 is formed along lower edges of inner surfaces of the four sidewalls 26. The step portion 261 is in a contact with an upper end portion 27 described later. A series of protrusions 262 are provided on inner surfaces of the step portion 261. Each of the protrusions 262 is tapered downward. The protrusions 262 are engaged with corresponding recesses 292 provided on outer surfaces of side wall 29 of the lower member 27. Distal ends of the side walls 26 are in a contact with a step portion 291 formed along upper edges of outer surfaces of the side walls 29 of the lower member 27 described later.

The lower member 27 has a bottom plate 28 and four side walls 29. The bottom plate 28 has a shape of rectangular. The four side walls 29 extend upward from four edges of the bottom plate 28. As described above, the step portion 291 is formed along the upper edges of outer surfaces of the four sidewalls 29. The step portion 291 is in a contact with the distal ends of the side walls 26 of the upper member 24. A series of recesses 292 are provided on outer surfaces of the step portion 291. The recesses 292 are engaged with corresponding protrusions 291 so that the upper and lower members can be engaged. Support ribs 293 are provided on inner surfaces of the side walls 29 of the lower member 27 to support the circuit board 30. More specifically, edges of the circuit board 30 are mounted on step portions 294 of the support ribs 293. Referring to FIG. 1, a power cable 99 passes through a side wall 29 of the lower member 27 into the case 23 and is connected to the circuit board 30. Although in the embodiment an AC power voltage of 100 or 240V is supplied to the circuit board 30 through the power cable 99, the present invention is not limited to it.

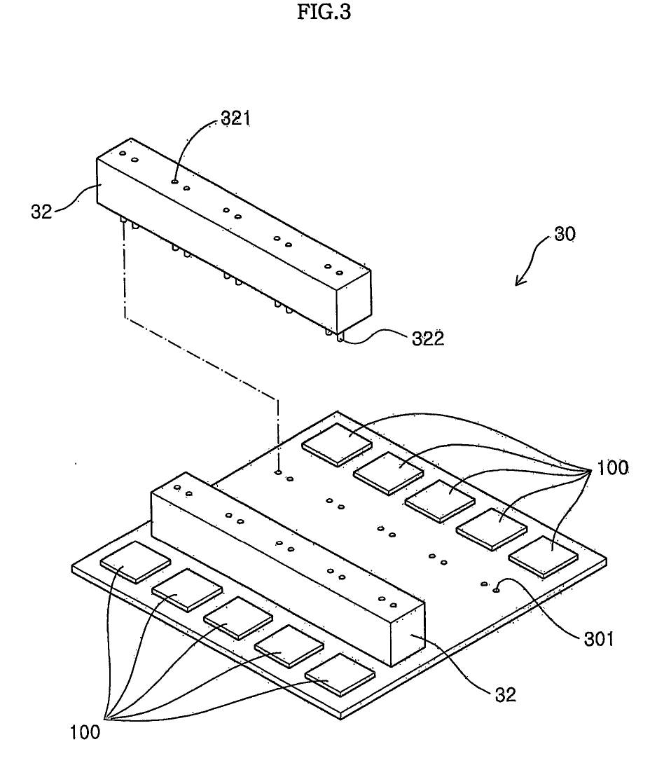

FIG. 3 is a perspective view of a circuit board in the decorative illuminating apparatus of FIG. 2. Referring FIGS. 2 and 3, two connectors 32 and a plurality of inverter IC chips 100 are provided on an upper surface of the circuit board 30. Each of the inverter IC chips 100 is electrically connected to a corresponding pair of pins 322 provided to the connector 32 and supplies an AC power to the connector 32. Each of the connectors 32 mounted on the circuit board 30 has a shape of an elongated bar. A plurality of pairs of inserting holes 321 are aligned on an upper surface of each of the connectors 32. And a plurality of pairs of pins 322 are aligned at the corresponding positions of the pairs of inserting holes 321 on a lower surface of each of the connectors 32. The upper surfaces of the connectors 32 are adjacent to the lower surface of the top plate 25 of the upper member 24. Each pair of the inserting holes 321 faces the corresponding through hole 254 below the first connection hole 253. The two conductors of the cable 44 passing through the through hole 254 are inserted and electrically connected to the inserting holes 321. The pins 322 are inserted into holes 301 on the circuit board 30 and fixed by a soldering method. As a result, the cable 42 is electrically connected to the circuit board 30 through a connector 32. As a plurality of connectors 32 are provided in parallel, the first connection holes 253 can correspond to the pairs of inserting holes 321.

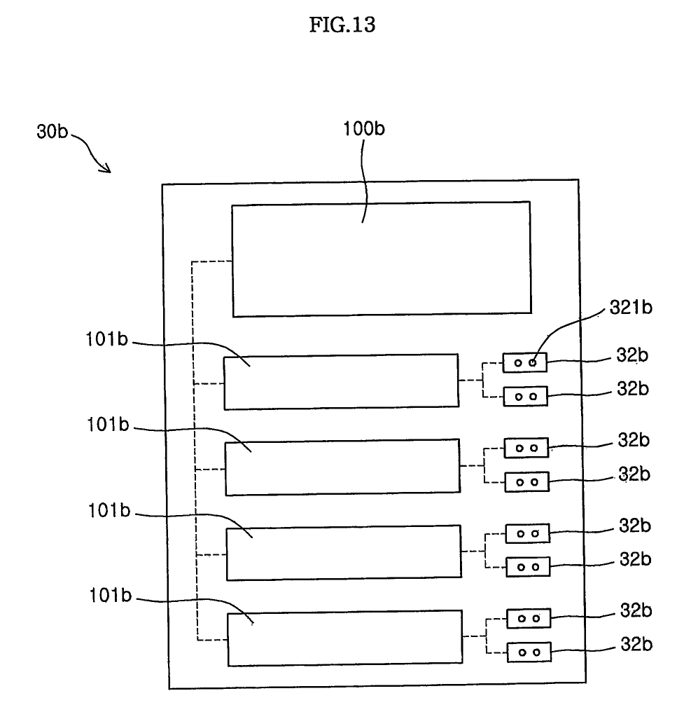

Although the commercial AC power is supplied to the decorative illuming object by using the inverter IC chips in the embodiment, the present invention is not limited to it. Alternative embodiments of circuit boards for supplying an electrical power to a decorative illuminating object are illustrated in FIGS. 13 and 14. Referring to FIG. 13, an adaptor circuit 100b, a plurality of inverter circuits 101b, and a plurality of connectors 32b are provided on a circuit board 30b. The adaptor circuit 101b converts and transforms an AC power voltage of 100 or 240V to a DC power voltage of 9˜12V, and supplies the DC power to the inverter circuits 101b. Each of the inverter circuits 101b is connected to the adaptor circuit 100b and two connectors 30b. Each of the inverter circuits 101b converts the DC power to a stable AC power used to illumination and applies the AC power to the two connectors 32b. Each of the connectors 32b has a pair of inserting holes 321b into which two conductors of a cable are inserted. It will be appreciated by those of ordinary skill in the art that a case suitable for such a circuit board can be implemented in accordance with the aforementioned embodiment.

Referring to FIG. 14, three connectors 32a, three transformers 101a, and three intensity adjusting elements 102a are provided on a circuit board 30a. An adaptor circuit (not shown) on the circuit board 30a converts and transforms an AC power voltage of 100 or 240V to a DC power voltage of 9˜12V. Each of the connector 32a has five pairs of inserting holes 321a into which conductors of cables are inserted. Each of the transformers 101a is connected to a corresponding connector 32a. Each of the transformers 101a supplies the DC power to the corresponding connector 32a. Each of the intensity adjusting elements 102a is connected to a corresponding transformer 101a. Outputs of the transformers 101a are adjusted by using the intensity adjusting elements 102a so that the intensity of light emitted from illuminating members 60 can be adjusted. It will be appreciated by those of ordinary skill in the art that a case suitable for such a circuit board can be implemented in accordance with the aforementioned embodiment. With such an arrangement of the circuit board, it is possible to supply different powers to groups of the illuminating members and separately adjust intensity of light emitted from groups of the illuminating members.

Although in the embodiment an AC power voltage of 100 or 240V is supplied to each of the connectors, the present invention is not limited to it. Instead of the AC power supplier, a DC power supplier such as a battery may be used. It will be appreciated by those of ordinary skill in the art that a power supplier suitable for such connectors can be implemented.

Although in the aforementioned the cable and the circuit board are connected to each other with the connectors, the present invention is not limited to it. Alternatively, the cable and the circuit board may be connected to each other by using a soldering method without a connector.

Returning to FIG. 1, the base 20 may be inserted in a vase-like container illustrated with dotted lines.

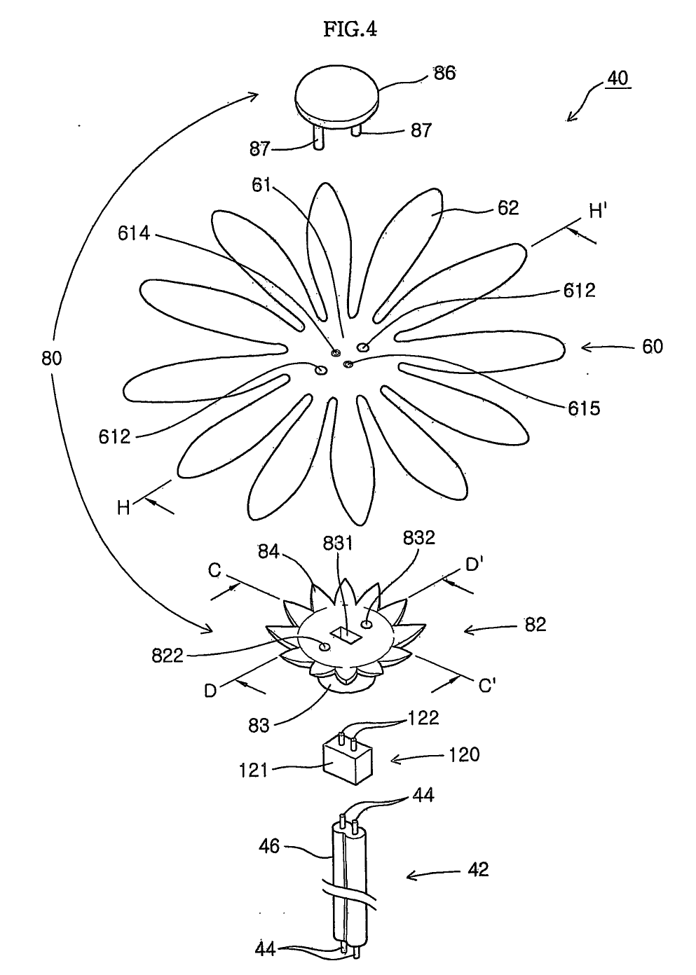

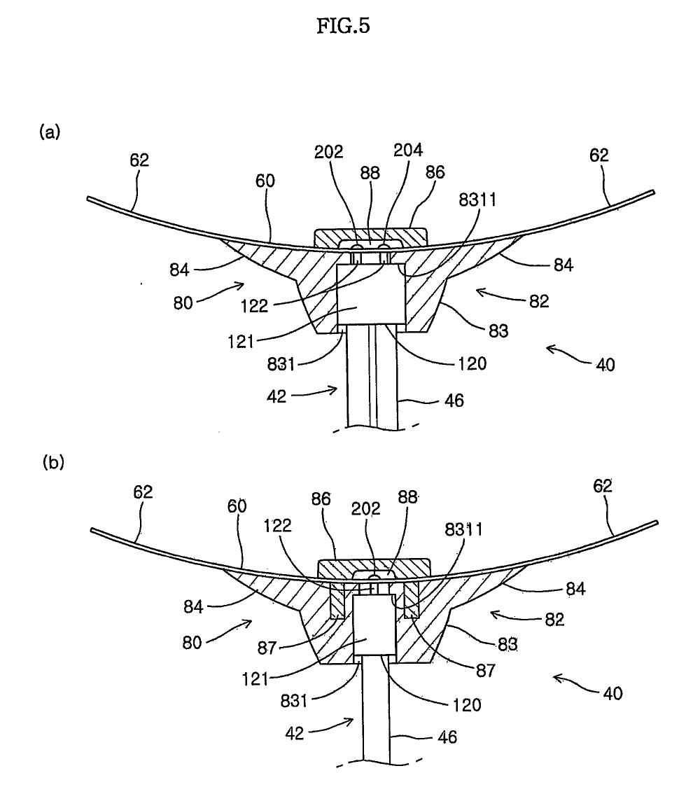

FIG. 4 is an exploded view of a decorative illuminating object in the decorative illuminating apparatus. FIG. 5 illustrates cross sectional views (a) and (b) taken along lines C-C′ and D-C′, respectively, of the decorative illuminating object of FIG. 4 with an illuminating member, a cable, and coupling means being assembled. In an embodiment of the present invention, the illuminating object 40 has a shape of a flower having a petal and a stem. The illuminating object 40 comprises a cable 40, an illuminating member 60, coupling means for coupling the cable 40 with the illuminating member 60, and a connector 120 for connecting the coupling member 80 and the cable 40. The illuminating member 60 and the cable correspond to the petal and stem of the flower, respectively. The coupling means represents a calyx and stamens of the flower. The cable 42 comprises two conductors covered with an insulating coat 46. At both ends of the cable 42, the insulating coat 46 is peeled to expose the two conductors 44. Returning to FIG. 2, the upper end of the cable 42 is inserted and fixed to the first connection hole 253, and the lower end of the cable 42 is inserted and fixed to the connector 120. Therefore, the cable 42 is not taken off by an unexpected external force. The two conductors 44 of the cable 42 inserted to the first connection hole 253 pass through the through hole 254 into the case 23 and are inserted to the inserting hole 321 of the connector 32. The cable 42 can be removed from the base 20 with a hand pulling. The cable 42 preferably has a strength to a degree that it can stand erect. The cable 42 may be elastically bendable.

Returning to FIGS. 4 and 5, the upper end of the cable 42 is inserted to the connector 120. The connector 120 has a body 121 having a shape of rectangular parallelepiped and two connection pins 112 provided on a top surface of the body 121. Two inserting holes (not shown) are provided on a bottom surface of the body 121, so that the two conductors 44 of the cable 42 pass through the two inserting holes and are connected to the two connection pins 122. The body 121 is received into a connection passage 831 of a support element 82 of the coupling means 80 described later. Two connection pins 122 are inserted into two inserting holes 614 and 615 of the illuminating member 60. The connector 120, the illuminating member 60, and the support element 82 are assembled by soldering (202, 204) or bending the pins. The two conductors 44 of the cable 42 are inserted/removed to/from the inserting holes (not shown) of the connector 120 assembled with the illuminating member 60 and the support element 82. With such an arrangement, it is possible to easily replace a blossom part made of the connector 120, the illuminating member 60, and the coupling means 80.

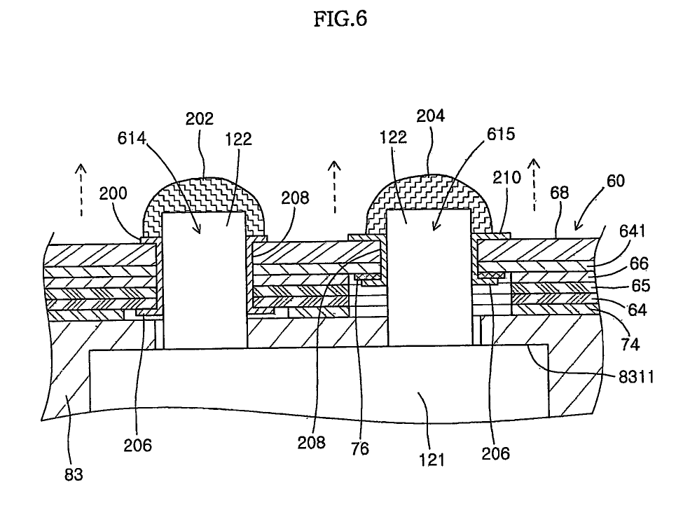

The illuminating member 60 having a shape of a petal comprises a circular central portion 61 and a plurality of extending portions 62 which extend from the central portion 61 in a radial direction. The central portion 61 comprises two coupling through holes 61 and first and second inserting holes 614 and 615. Preferably, the two coupling through holes 61 and the first and second inserting holes 614 and 615 are arranged so that a line connecting the two coupling through holes 612 can intersect a line connecting the first and second inserting holes 614 and 615. The coupling means 80 further comprises a fixing element 86. The fixing element 86 has an insert boss 87 which are inserted into the coupling through holes 612. The first and second inserting holes 614 and 615 are lined with first and second connection rings 200 and 210 described later with reference to FIG. 6. The two connection pins of the connector 120 are inserted into the first and second inserting holes 614 and 615 and are fixed with the solders 202 and 204. Although the connection pins are fixed with the solders, the connection pins are fixed by inserting the connection pins and bending protruding portions thereof. In addition, the bended portion may be also soldered.

FIG. 8 is a perspective view of one of the connection rings 200 and 210 before lined in the first and second inserting holes 614 and 615. Now, a method of lining the connection rings in the first and second inserting holes will be described. Each of the connection rings 200 and 210 comprises a cylinder 208 and a flange 206 having a knob 209. With a hand gasping the knob 209, the cylinder 208 is inserted into the inserting hole of the illuminating member 60. Next, a sintering process is performed on the opposite portion of the flange 206, so that the first and second connection rings 200 and 201 are lined in the first and second inserting holes 614 and 615 of the illuminating member 60. Next, the knob 209 is removed.

FIG. 6 is an enlarged cross sectional view of an assembled portion of the illuminating member 60 and the cable 40. The illuminating member, that is an EL sheet, has a stacked structure of a coating layer 68, a transparent conductive layer (transparent electrode layer) 641, a fluorescent layer 66, a dielectric layer 65, a lower electrode layer 64, and a moisture proof layer 74, as shown in FIG. 6. The lower electrode layer 64 is made of a highly conductive material such as silver. The fluorescent layer 66 is formed by depositing fluorescent ink. The fluorescent layer 66 is generally referred to as a phosphor layer. In FIG. 6, the arrows indicate Light emitted from the illuminating member. The coating layer 68 is made of a transparent material such as PE in the embodiment. The transparent electrode layer 641 is an indium oxide tin (ITO) film made by depositing ITO on a plastic resin film, such as PET. It will be appreciated by those of ordinary skill in the art that depths of the layers in FIG. 6 is different from those of actual layers of the illuminating member 60. The present invention is not limited to the aforementioned structure of the EL sheet. It will be appreciated by those of ordinary skill in the art that different structures of the EL sheet can be employed.

Referring to FIG. 6, the stacked structures near the first and the second inserting holes 614 and 615 of the illuminating member 60 are different from each other. Near the first inserting holes 614, the moisture proof layer 74 is removed wider than the flange 206 of the first connection ring 200. The lower electrode layer 64 is exposed at the region where the moisture proof layer 74 is not formed. The flange 206 of the first connection ring 200 contacts with the exposed portion of the lower electrode layer 64 and the opposite portion of the flange is caulked, so that the first connection ring 200 and the illuminating member 60 are assembled and the formation of the first inserting hole 614 is completed. Near the second inserting hole 615, the moisture proof layer 74, the lower electrode layer 64, the dielectric layer 65, and the fluorescent layer 66 are removed wider than the flange 206 of the second connection ring 210. As a result, the transparent electrode layer 641 is exposed. A connection electrode layer 76 is formed on the exposed transparent electrode layer 641. The connection electrode layer 76 is made of a highly conductive material such as silver. The flange 206 of the second connection ring 210 contacts with an outer surface of the connection electrode layer 76, and the opposite portion of the flange is caulked, so that the second connection ring 210 and the illuminating member 60 are assembled and the formation of the second inserting hole 615 is completed. The two connection pins of the connector 120 are inserted into the first and second inserting holes 614 and 615, and the solders 201 and 204 are applied. With such a structure, the one connection pin inserted into the first inserting hole 614 is electrically connected to the lower electrode layer 64 of the illuminating member 60, and the other connection pin inserted into the second inserting hole 615 is electrically connected to the transparent electrode layer 641 of the illuminating member 60.

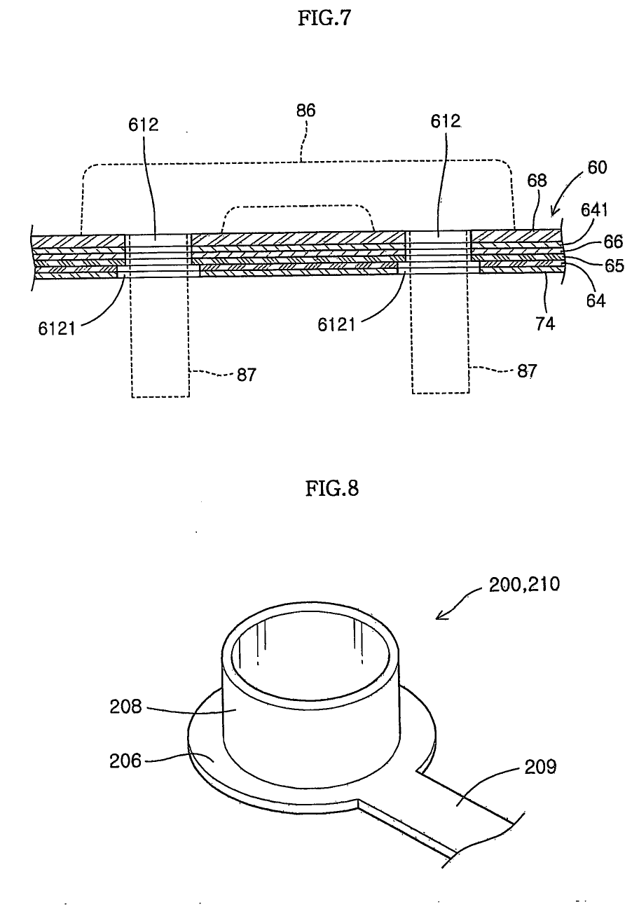

FIG. 7 is a cross sectional view taken along a line H-H′ of the decorative illuminating object of FIG. 4 in order to illustrate two coupling through holes 612. The stacked structures near the two coupling through holes 612 of the illuminating member 60, to which the two insert bosses 87 of the fixing element 86 of the coupling member 80 are inserted, are slightly different from that of other regions of the illuminating member 60. Near each of the coupling through holes 612, the moisture proof layer 74 and the lower electrode 64 are removed to expose the dielectric layer 65. As a result, it is possible to prevent the lower electrode layer 64 and the transparent electrode layer 641 from being crushed during the formation of the coupling through holes 612 and to ensure a stable connection.

Returning to FIGS. 4 and 5, the coupling means 80 comprises the support element 82 and the fixing element 86. The support element 82 and the fixing element 86 represent a calyx and stamens of a flower, respectively. The support member 82 has a connection portion 83 and a plurality of sepal-like supports 84. The connection portion has a shape of a truncated cone. The plurality of sepal-like supports 84 are provided in a radial direction to correspond to the plurality of extending portions 62 of the illuminating member 60. The connection portion 83 comprises a connection passage 831 at the center thereof and two inserting holes 822 and 832 at the both sides of the connection passage 831. The connector 120 is inserted to the connection passage 831. Referring to FIG. 5, the connection passage 831 has a protruded rim 8311 at the upper inner surface thereof. The rim 8311 has a function of preventing the connector 120 from passing the connection passage 831. The two connection pins of the connector 120 are protruded through an upper opening of the connection passage 831. The two insert bosses 87 of the fixing element 86 are pressed and inserted into the two inserting holes 822 and 832 provided on the upper surface of the connection portion 83, so that the support element 82 and the fixing element 86 are assembled. Each of the sepal-like supports 84 having a shape of a rising curve supports the corresponding extending portion 62 of the illuminating member 60.

Referring to FIGS. 4 and 5, the fixing element 96 having a shape of stamens comprises the two inserting bosses extending downward and a recess 88 at the center of a lower surface of the fixing element 96. The two insert bosses 87 pass through the coupling through holes 612 of the illuminating member 60, and are pressed and inserted into the two inserting holes 822 and 832, so that the illuminating member 60 can be fixed. The recess 88 receives the solders 202 and 204 formed at the two connection pins of the connector 120.

Returning to FIGS. 1 and 2, the decorative non-illuminating object 90 comprises a lower end portion 92 and a decorative portion 94. The lower end portion having a cross section of circle are connected to the second inserting hole 255 provided on the top surface of the base 20. The decorative portion may have various shapes such as a flower, a butterfly, a cattail, or the like.

Now, operations of the decorative illuminating apparatus will be described with reference to FIGS. 1, 2, 5, and 6. AC power is supplied to the circuit board 30 in the base 20 through the power cable 99. The circuit board 30 is connected to the cable 42 of the decorative illuminating object 40 through the connector 32 provided on the upper surface of the circuit board 30. An inverter IC chip 100 supplies a stable AC power to the illuminating member 60 through the cable passing through an inserting hole 321. Referring to FIG. 6, the one of the two connection pins of the connector 120 is connected to the lower electrode layer 64 through the first connection ring 200, and the other is connected to the transparent electrode layer 641 through the second connection ring 210. As the AC current flows between the two electrode layers, light emits toward the coating layer 68. Initially, the first connection ring 200 is connected to the transparent electrode layer 641 and the lower electrode layer 64. At the time of a current flowing, the transparent electrode layer 641 near the first connection ring 641 is damaged and insulated. As a result, the first connection ring 200 is connected to only the lower electrode layer 64. On the other hand, some portion of the transparent electrode layer 641 near the second connection ring 210 may be damaged, but the lower electrode layer 64 covering the transparent electrode layer 641 is not insulated. As a result, the conductors 44 and the transparent layer 641 are still electrically connected to each other, so that light can continuously emit.

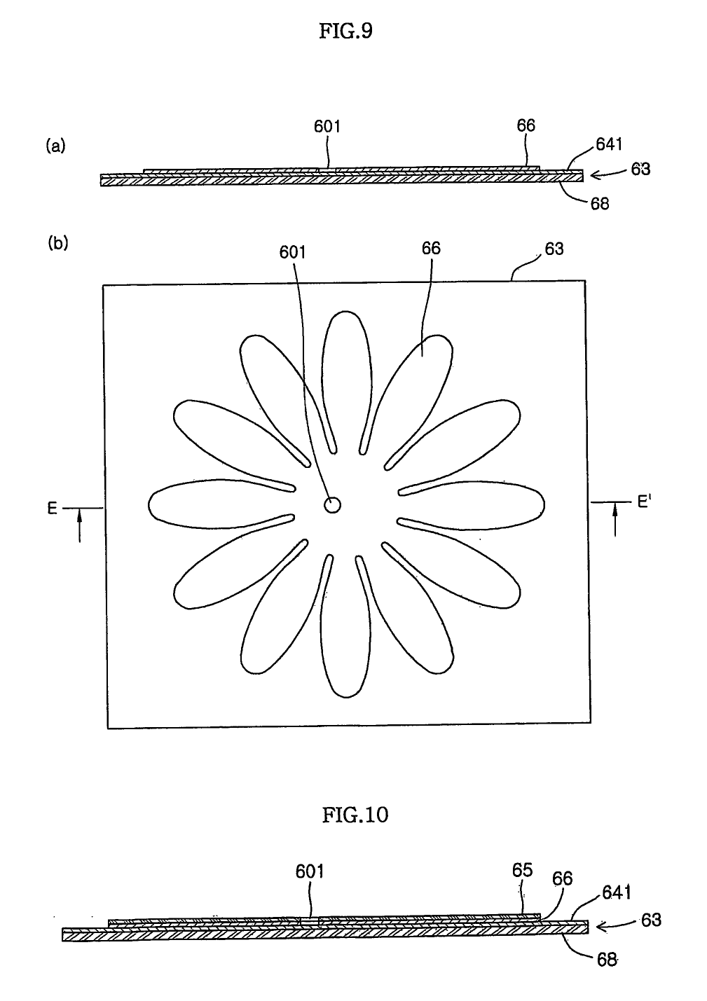

Now, a method of fabricating the illuminating member 60 illustrated in FIGS. 4, 5, and 7 will be described with reference to FIGS. 9, 10, 11, and 12. Firstly, as shown in (a) and (b) of FIG. 9, a fluorescent layer 66 having a shape of a flower is formed on a substrate 63. In FIG. 9, (a) is a plan view of the substrate 63 and (b) is a cross sectional view taken along the line E-E′ of the substrate of (a). The fluorescent layer 66 is not at a predetermined central region 601. It is the predetermined central regions 601 that the second connection ring shown in FIG. 6 is inserted into. The substrate 63 comprises a coating layer 68 and the transparent electrode layer 641. In the embodiment, the coating layer 68 is made of a transparent plastic material such as PE, and the transparent electrode layer 641 is made of an indium oxide tin (ITO) film.

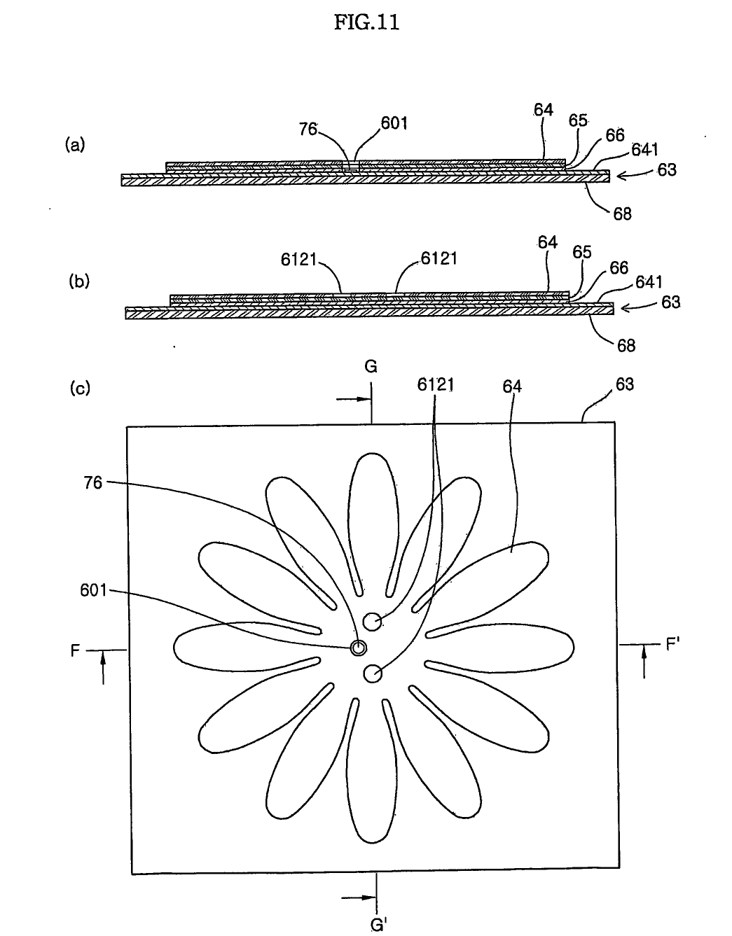

Next, as shown in FIG. 10, a dielectric layer 65 is formed on the fluorescent layer 66. The dielectric layer 65 has the same shape as the fluorescent layer 66. Next, as shown in FIG. 11, a lower electrode layer 64 made of a highly conductive material such as silver is formed on the dielectric layer 65. In FIG. 11, (c) is a plan view, and (a) and (b) are cross sectional view taken along lines F-F′ and G-G′ of (c) of FIG. 11. After the formation of the lower electrode layer 64, the lower electrode layer 64, the dielectric layer 65, and the fluorescent layer 600 are removed at a predetermined region 601 to expose the transparent electrode layer 641. On the exposed transparent electrode is formed a connection electrode layer 76 which are apart from the neighboring layers. The connection electrode 76 is made of a high conductive material such as silver. On the other hand, the lower electrode layer 64 is removed at two predetermined regions 8121 where the coupling through holes 612 of FIGS. 4 and 7 are to be formed.

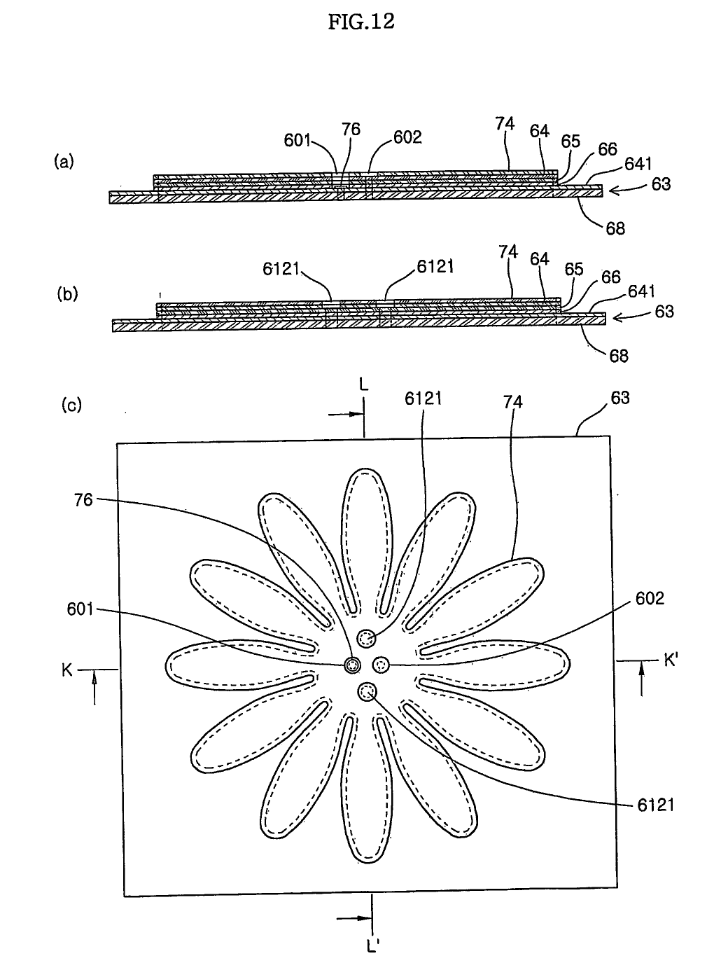

Next, as shown in FIG. 12, a moisture proof layer 64 is formed. In FIG. 12, (c) is a plan view, and (a) and (b) are cross sectional view taken along lines K-K′ and L-L′ of (c) of FIG. 12. Next, the moisture proof layer 64 is removed at predetermined regions 601 and 602 where the first connection ring 200 of FIG. 6 is to be inserted. On the other hand, the moisture proof layer 64 is removed at other predetermined regions 6121 where the coupling through holes 612 are to be formed. Although the moisture proof layer 64 is removed at the predetermined region 6121, the present invention is not limited to it. Alternatively, the moisture proof layer 64 may not be removed at the predetermined region 6121. Next, the substrate is subjected to a cutaway process for cutting the substrate along the contour of a flower indicated with dotted line in (c) of FIG. 12, so the illuminating member having a shape of a flower can be obtained. After or before the cutaway process, a punching process is performed to form two coupling through holes 621 and two inserting holes 614 and 615 which are lined with first and second connection rings 200 and 210. When the two inserting holes 614 and 615 are lined with the first and second connection rings 200 and 210, the illuminating member 60 shown in FIG. 4 is completed.

Although the layers in FIGS. 9 to 12 are illustrated to be thick, it will be appreciated by those of ordinary skill in the art that thicknesses of the layer are exaggerated.

Although only a single flower is formed on the substrate 63 in FIGS. 9 to 12, it will be appreciated by those of ordinary skill in the art that a large number of flowers can be formed on the substrate 63 for the purpose of mass production.

Although the illuminating member has a shape of a flower in the aforementioned embodiment, the present invention is not limited to the flower. It will be appreciated by those of ordinary skill in the art that the illuminating member may have various shapes such as a butterfly, a dragonfly, a mushroom, a bird, a charter, a numeral, and a symbol.

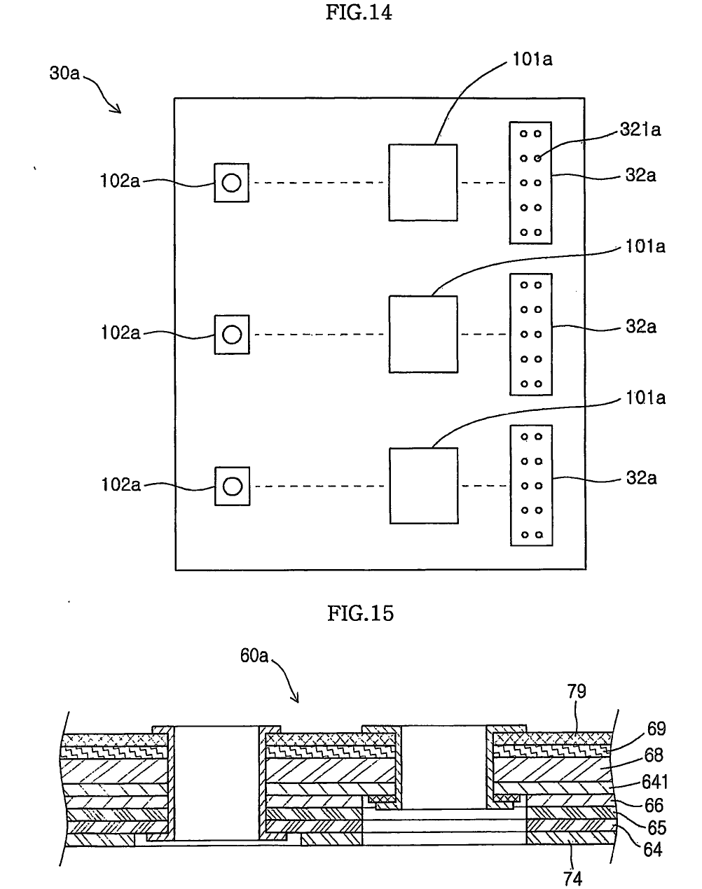

FIG. 15 is a cross sectional view of an illuminating member 60a according to an embodiment of the present invention. The illuminating member 60a comprises a coating layer 68, a printing layer 69, and a glossing layer 79. The printing layer 69 is formed by printing a desired figure of a flower or a star on the coating layer 68 with a printing process, such as a silk screen method and an offset printing method. With the formation of the printing layer 69, it is possible to obtain an illuminating member having naturally or three-dimensionally appearance during its illumination. The glossing layer 79 is formed by coating a non-glossy material or a glossy material on the printing layer 69. With the formation of the glossing layer 79, it is possible to further increase the aforementioned printing effect. The other structures of the illuminating member 60a are the same as the illuminating member 60 of FIG. 6, and thus their description is omitted.

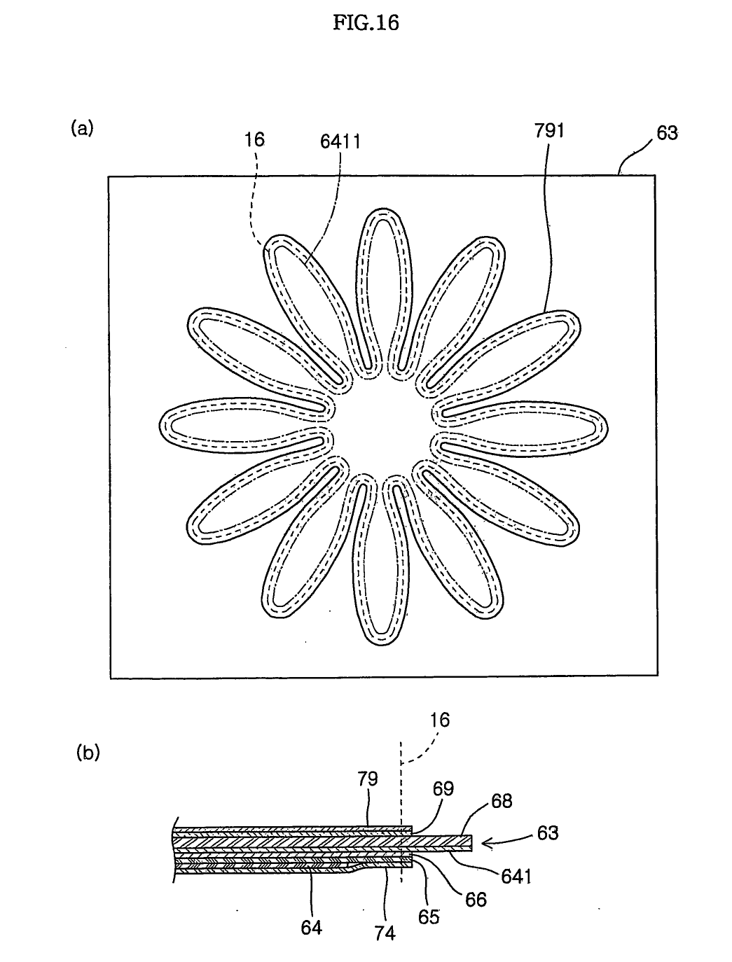

FIG. 16 illustrates a method of fabricating an illuminating member according to another embodiment of the present invention. Referring to (a) and (b) of FIG. 16, contour 64111, that is, an outer end portion, of the lower electrode layer 64 is formed to be interior to contours of the substrate 63 (including the dielectric layer 65 and the moisture proof layer 74, and so on) and other layers (including the glossing layer 79, the printing layer 69). The resulting member is subjected to a cutaway process for cutting the resulting member along the dotted line 16 drawn between the contour of the lower electrode layer 64 and the contours of the other layers 79, 69, 66, 65, 74. As a result, an illuminating member having a desired shape of a flower is obtained. By doing so, it is possible to prevent the lower electrode layer 64 from being exposed. Therefore, an unpleasant electric shock can be avoided when the illuminating member contacts with a human body. The other structures of the illuminating member are the same as the aforementioned embodiment, and thus their description is omitted.

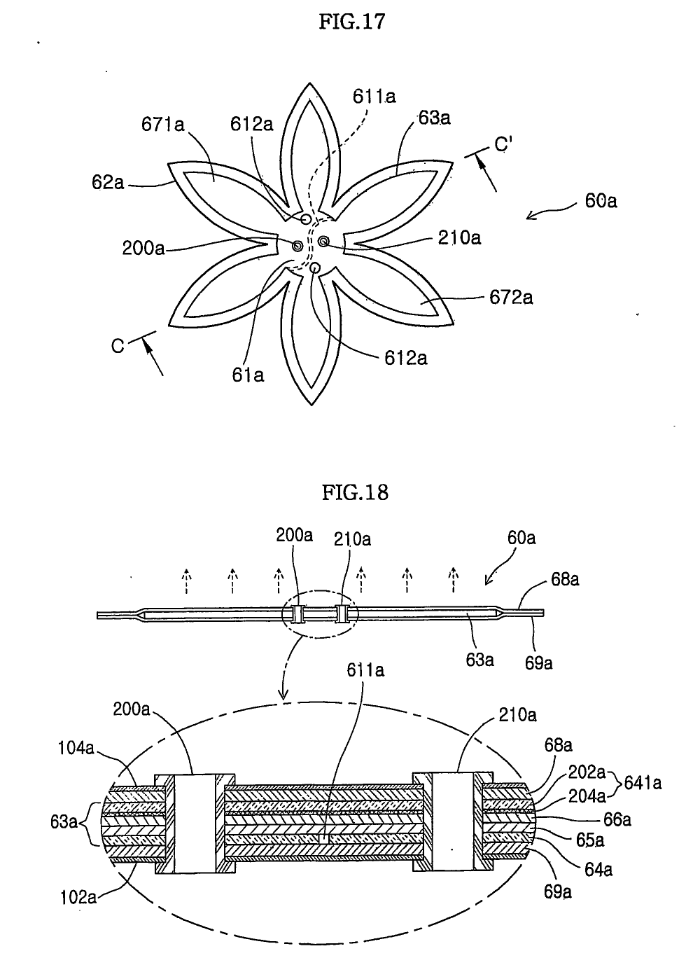

FIGS. 17 and 18 illustrate an illuminating member 60a according to anther embodiment of the present invention. The illuminating member 60a havening a shape of a flower comprises a circular central portion 61a and a plurality of extending portions 62a which extend from the central portion 61a in a radial direction. The illuminating member further comprises an EL sheet 63a and insulating coating layers 68a and 69a for covering the EL sheet 63a. The EL sheet 63a has a stacked structure of a base layer 641a, a fluorescent layer 66a, an insulating layer 66a, and a conductive layer 64a. The insulating layer 65a is made of a dielectric material. The conductive layer 64 made of a highly conductive material such as silver serves as an electrode. The fluorescent layer 66a is formed by depositing fluorescent ink. The fluorescent layer 66a is generally referred to as a phosphor layer. In alternative embodiment, an insulating layer may be interposed between the base layer 641a and the fluorescent layer 66a. Since the light-emitting surface of the EL sheet 63a is directed upward in FIG. 18, the base layer 641a is illustrated at the upper portion of the EL sheet 63a. In FIG. 18, the arrows indicate Light emitted from the illuminating member 60a. The base layer 641a made of a transparent conductive material comprises a base resin layer 202a and a conductive film 204a. Preferably, the base resin layer 202a is made of a plastic resin material such as PET, and the conductive film is an indium oxide tin (ITO) film made by depositing ITO on the base resin layer 202a. The resulting base layer 641a is referred to as a transparent conductive film or an ITO film layer. It will be appreciated by those of ordinary skill in the art that depths of the layers in FIG. 18 is different from those of actual layers of the illuminating member 60.

Referring to FIGS. 17 and 18, there is provided a dividing line 611a for dividing the conductive layer 64a into two parts. The dividing line is formed to be a curve having a certain width. The present invention is not limited to the embodiment, but the dividing line may be formed to be linear.

Referring to FIG. 18, two printing layer 104a and 102a are formed on two coating layers 68a and 69a, respectively. The coating layers 68a and 89a are wider than an EL sheet 63a, so that the EL sheet 63a is not exposed. The dividing line 611a divides the conductive layer 64a provided in the central portion 61a of the EL sheet 63a into two electrode planes 671a and 672a. When an AC voltage is applied between two electrode planes 671a and 672a connected to the corresponding conductors, light emits from the transparent electrode layer (the base layer) 641a.

Referring to FIG. 17, two coupling through holes 612a and first and second connection rings 200a and 210a are provided on the two electrode planes 61a and 672a of the central portion 61a. The first and second connection rings 200a and 210a have the same structures as those of FIG. 6. The first and second connection rings 200a and 210a pass through all the layers of the illuminating member 60a. The illuminating member 60a is connected to a cable in the same manner shown in FIGS. 4 and 5. As not shown in FIG. 17, two conductors of the cable are electrically connected to the first and second connection rings 200a and 210a, respectively. When currents are applied to the first and second connection rings 200a and 210a, a short circuit may occur at the conductive film 204a of the base layer 641a. However, heat generated at that time have a damage to the conductive films 204a near the first and second connection rings 200a and 210a, so that the first and second rings 200a and 210a can be insulated from the conductive films 204a. Therefore, there is no influence on the illumination of the illuminating member 60a.

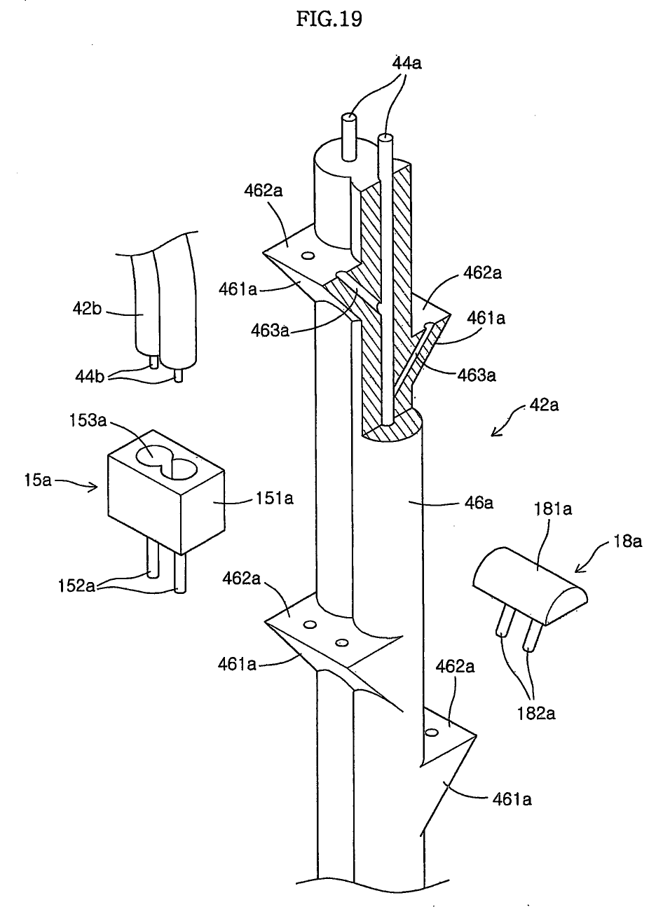

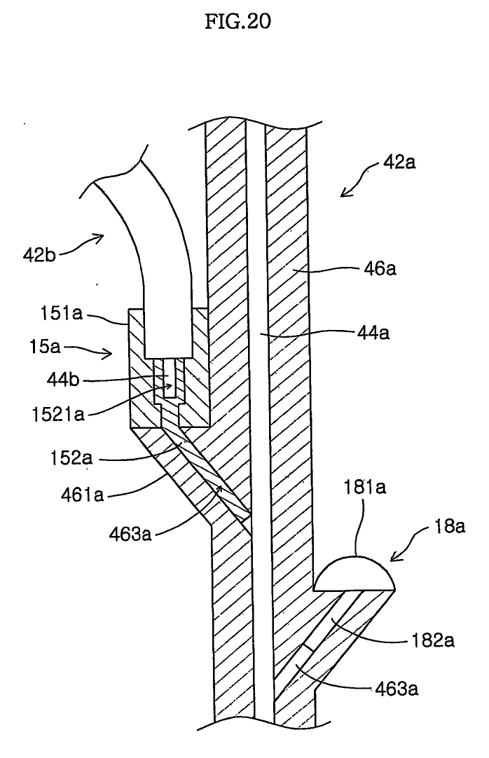

FIGS. 19 and 20 illustrate a cable 42a according to another embodiment of the present invention. The cable 42a represents a stem of a plant which is represented by a decorative illuminating object. FIG. 19 is a perspective, partially cutaway view of the cable 42a and other connection parts 461a according to another embodiment of the present invention; and FIG. 20 is a cross sectional view of additional cables connected to a cable connection portion of FIG. 17. The cable 42a comprises two conductors 44a for flowing a current and an insulating coat 46a covering the two conductors 44a. A plurality of connection parts 461a are provided on the insulating coat 46a. Hereinafter, the cable 42a is referred to as a “stem cable.” Each of the connection parts 461a has a connection plane 462a substantially perpendicular to an extending direction of the conductors 44a. In each of the connection parts 461a, two connection passages 463a are provided from the connection plane 462a and to the two conductors 44a, respectively. When a connector 15a described later is mounted on the connection plane 42a, two leads of the connector 15a are inserted into the connection passages and electrically connected to the conductors 44a. An additional cable (hereinafter, referred to as a “branch cable”) representing a branch of the plant is connected through the connector 15a. Preferably, the branch cable is more slender than the stem cable. However, the present invention is not limit to it. The connector 15a has a body 151a having a shape of rectangular parallelepiped and two leads extending downward from the body 151a. An opening 153a is provided on a top portion of the body 151a to fasten the branch cable 42a. In the opening 153a are provided connection portions 1521a of the leads 152a to which the two conductors of the branch cable 42b are inserted and connected. The leads 152a are inserted into the connection passages 463a provided at the connection parts 461a of the stem cable 42a. The end portion of the inserted lead 152a is electrically connected to the conductor 44a of the stem cable 42a. When a branch cable 42b is not connected to a connection part 461a of the stem cable 42a, a cap 18a is inserted the connection part 461a in order to prevent contaminants from being flowing into the connection part 461a. The cap 18a comprises a cover 181a for covering the connection plane 462a of the connection part 461a of the stem cable 42a and legs 182a extending from the cover 181a. The two legs are inserted into the two connection passages 463 provided to each of the connection parts of the stem cable 42a.

According to the present invention, the following advantages can be obtained. It is possible to use the decorative illuminating apparatus as an illumination apparatus. In addition, since a plurality of stem and branch cables are easily detachable to a base through a plurality of connection parts and portions, a user can decorate the decorative illuminating apparatus to his or her taste. In addition, it is possible to firmly assemble the cable and the illuminating member. In addition, since the cable can be easily detachable from the decorative illuminating object, it is possible to easily replace their components. In addition, according to a method of fabricating the illuminating member by using an EL sheet, it is possible to fabricate various shapes of the illuminating members in mass production. In addition, since the EL sheet has a moisture proof layer, it is possible to increase life time and durability of the decorative illuminating apparatus. In addition, since a desired figure is printed on the illuminating member and a glossing layer is formed thereon, it is possible to obtain three-dimensional appearance during the illumination of the illuminating member. In addition, since conductive layers in the illuminating member are not exposed, it is possible to avoid an unpleasant electric shock when the illuminating member contacts with a human body. In addition, since different powers can be supplied to groups of the illuminating members, light can more stably emit from a plurality of the illuminating members. In addition, since a plurality of branch cable can be added to a stem cable, it is possible to simply and easily obtain a plant-like decorative illuminating apparatus.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A decorative illuminating apparatus comprising: an illuminating member having a shape of a sheet, the illuminating member comprising a transparent conductive layer, a fluorescent layer, and first and second electrode layers electrically isolated from each other,
wherein electrical connection portions are provided to the first and second electrode layers of the illuminating member, and
wherein a conductive wire passes through each of the electrical connection portions.

2. The decorative illuminating apparatus according to claim 1, wherein the second electrode layer is in a contact with the transparent conductive layer.

3. The decorative illuminating apparatus according to claim 2, wherein the fluorescent layer is interposed between the transparent layer and the first electrode layer, wherein the transparent layer is exposed at a region where the fluorescent layer and the first electrode layer are not formed, and wherein the second electrode layer covers the exposed region of the transparent layer and is electrically isolated from the electrode layers.

4. The decorative illuminating apparatus according to claim 1, wherein the fluorescent layer extends between the first electrode layer and the transparent layer and between the second electrode layer and the transparent layer.

5. The decorative illuminating apparatus according to any one of claims 1 to 4, wherein the decorative illuminating apparatus further comprises a cable for supplying an electrical power to the electrical connection portions, wherein the cable has two conductors.

6. The decorative illuminating apparatus according to claim 5 wherein the decorative illuminating apparatus further comprises a connector having two connection pins connected to the electrical connection portions, and wherein the two conductors of the cable are separately connected to the connector.

7. The decorative illuminating apparatus according to claim 6, wherein the decorative illuminating apparatus further comprises first and second connection rings passing through the illuminating member and connected to the electrical connection portions, and
wherein the two connection pins of the connector are inserted into the first and second connection rings, respectively.

8. The decorative illuminating apparatus according to any one of claims 1 to 4, wherein the illuminating member further comprises a moisture proof layer at the opposite side of a light-emitting side of the illuminating member.

9. The decorative illuminating apparatus according to any one of claims 1 to 4,
wherein the illuminating member further comprises a printing layer at a light-emitting side of the illuminating member, and
wherein a figure is printed on the printing layer.

10. The decorative illuminating apparatus according to any one of claims 1 to 4, wherein the illuminating member further comprises a layer covering outer end portions of the first or second electrode layer so that the first or second electrode layer is not externally exposed.

11. The decorative illuminating apparatus according to any one of claims 1 to 4,
wherein the illuminating member comprises a central portion and a plurality of extending portions extending from the central portion in a radial direction, thereby forming a flower-like shape, and
wherein the electrical connection portion is provided at the central portion.

12. The decorative illuminating apparatus according to claim 11,
wherein the decorative illuminating apparatus further comprises a coupling means having a support element and a fixing element,
wherein the illuminating member is interposed between the support element and the fixing element,
wherein the support element and the fixing element are detachably assembled, and
wherein the coupling means covers the electrical connection portion.

13. The decorative illuminating apparatus according to any one of claims 5 to 11, wherein the decorative illuminating apparatus further comprises a base where the cable is detachably fixed.

14. The decorative illuminating apparatus according to claim 13, wherein the base comprises an inserting hole where the cable is inserted and fixed.

15. The decorative illuminating apparatus according to claim 14,
wherein the base comprises a circuit board having a connector, and
wherein the two conductors of the cable are connected to the connector of the circuit board.

16. The decorative illuminating apparatus according to claim 5,
wherein the decorative illuminating apparatus further comprises a circuit unit for supplying an electrical power through the cables, and
wherein the circuit unit comprises a plurality of inverter devices corresponding to the cables.

17. The decorative illuminating apparatus according to claim 5,
wherein the decorative illuminating apparatus further comprises a circuit unit for supplying an electrical power through the cables,
wherein the cables are divided into groups having one or more cables, and
wherein separate power supply devices are provided to the groups.

18. A decorative illuminating apparatus comprising:
an illuminating member made of an EL sheet; and
a cable used for supplying an electrical power to the EL sheet,
wherein the cable comprises:
two conductors; and
an insulating coat for covering the two conductors, and
wherein a connection passages is provided to the insulating coat to connect with each of the two conductors.

19. The decorative illuminating apparatus according to claim 18, wherein the decorative illuminating apparatus further comprises a branch cable which is connected to the cable through the connection passage.

20. A method of fabricating an illuminating member, the method comprising steps of:
preparing a transparent electrode layer;
forming a fluorescent layer on the transparent electrode layer except for a first region of the transparent layer, thereby exposing the first region and forming an exposed transparent layer;
forming a dielectric layer on the fluorescent layer except for the first region, thereby still exposing the exposed transparent layer;
forming a first electrode layer on the dielectric layer except for the first region, thereby still exposing the exposed transparent layer; and
forming a second electrode layer at the same time, after, or before the step of forming the first electrode layer, wherein the second electrode layer covers the exposed transparent layer and is apart from the first electrode layer.

21. The method of fabricating an illuminating member according to claim 20, wherein the method further comprise a step of forming a moisture proof layer on the first electrode layer.

22. The method of fabricating an illuminating member according to claim 21, wherein the moisture proof layer is formed except for a second region of a lower electrode layer, thereby exposing the second region of the electrode layer.

23. The method of fabricating an illuminating member according to claim 22, wherein, in the step of forming the electrode layer, the electrode layer is formed so that a third region of the dielectric layer is exposed, wherein the method further comprises a step of forming a through hole having a smaller size than the third region.

24. The method of fabricating an illuminating member according to any one of claims 20 to 23, wherein the method further comprise a step of forming a printing layer by printing a desired figure on the transparent electrode layer.

25. The method of fabricating an illuminating member according to claim 24, wherein the method further comprise a step of forming a glossy layer on the printing layer.

26. The method of fabricating an illuminating member according to claim 20, wherein outer end portions of the first electrode layer is covered with other layers.

27. A decorative apparatus comprising:
an illuminating member made of an EL sheet, the illuminating member comprising a central portion and a plurality of extending portion, thereby the illuminating member having a shape of a flower;
a cable connected to the EL sheet, the cable having a shape of a stem; and
a power supply device for supplying an electrical power to the EL sheet through the cable.

28. The decorative apparatus according to claim 27, wherein the decorative apparatus further comprises another EL sheet having a shape of a petal, wherein the power supply device supplies the electrical power to another EL sheet.
